(19) United States
(12) Patent Application Publication
(10) Pub. No.: US 2013/0200104 A1
(43) Pub. Date: Aug. 8, 2013

(54) THERMAL DEVICE FOR PERSONAL HYDRATION SYSTEMS

(71) Applicants: Andrew Benjamin Whitehead, St. Louis, MO (US); Richard Louis Brophy, St. Louis, MO (US)

(72) Inventors: Andrew Benjamin Whitehead, St. Louis, MO (US); Richard Louis Brophy, St. Louis, MO (US)

(21) Appl. No.: 13/758,727

(22) Filed: Feb. 4, 2013

Related U.S. Application Data
(60) Provisional application No. 61/595,738, filed on Feb. 7, 2012.

(51) Int. Cl. B67D 3/00; F24H 9/00

(52) U.S. Cl. CPC B67D 3/0022; F24H 9/00
USPC 222/146.5; 432/219; 222/175

(57) ABSTRACT

A thermal control device for a personal hydration system includes a sheath for covering a fluid delivery conduit of the personal hydration system. The device includes a thermal device in thermal communication with the sheath and configured to heat at least a portion of the fluid delivery conduit when the thermal device is energized. An energy source is in communication with the thermal device for energizing the thermal device.

### CROSS REFERENCE TO RELATED APPLICATIONS

This application claims priority to provisional application No. 61,595,738, filed Feb. 7, 2012, the disclosure of which is hereby incorporated by reference in its entirety.

### FIELD

The field of the present disclosure relates generally to thermal devices for hydration systems and more particularly, to thermal devices for heating drinking conduits, such as straws and the like.

### BACKGROUND

The importance of staying hydrated is well recognized. Typically, individuals carry refillable containers, such as water bottles or personal hydration packs (such as those manufactured by Camelbak®). These refillable containers allow a user to drink substantially continuously while engaged in sporting, athletic, or other recreational activities. Refillable containers of the personal hydration pack type, typically include a bag-like fluid reservoir that is carried in a backpack or waist pack and have a long flexible tube, or conduit, (e.g., straw) that extends from the reservoir to a mouthpiece, which enables a user to drink fluid from the reservoir.

Depending on the activity, the refillable containers may be subjected to freezing temperatures (or atmospheric conditions), for example during winter sports such as skiing, snowboarding, alpine hiking and the like. Additionally, high altitudes may also be encountered during such activities. Freezing temperatures and/or high altitudes may cause liquid inside the refillable container, flexible tube, or mouthpiece to freeze. After the liquid has frozen in the refillable container, a user may be prevented from receiving liquid from the refillable container. In other circumstances, the frozen liquid may cause damage to the refillable container due to expansion.

### BRIEF DESCRIPTION

In one aspect, a thermal control device for a personal hydration system includes a sheath for covering a fluid delivery conduit of the personal hydration system. The device includes a thermal device in thermal communication with the sheath and configured to heat at least a portion of the fluid delivery conduit when the thermal device is energized. An energy source is in communication with the thermal device for energizing the thermal device.

In another aspect, a personal hydration system includes a fluid reservoir configured to hold a quantity of liquid and a fluid delivery conduit in fluid communication with the reservoir. A thermal device is in thermal communication with the fluid delivery conduit and is configured to transmit thermal energy to at least a portion of the fluid delivery conduit. An energy supply is in communication with the thermal device and configured to energize the thermal device.

In yet another aspect, a thermal system for a personal hydration system includes a thermal device configured to be in thermal communication with at least a portion of the personal hydration system and an energy source in communication with the thermal device and configured to selectively energize the thermal device.

### BRIEF DESCRIPTION OF THE DRAWINGS

FIGS. 1-2 illustrate perspective views of an exemplary personal hydration system.

FIG. 3 illustrates an embodiment of the personal hydration system with a portion of the cover removed to show a reservoir.

FIG. 4 shows an exemplary fluid delivery conduit for use with an embodiment of the personal hydration system.

FIGS. 5-6 illustrate cross-sections of an embodiment of the fluid delivery conduit.

FIG. 7 illustrates a perspective view of a sheath for use with an embodiment of the personal hydration system.

FIG. 8 is a schematic illustration of an embodiment of a thermal device.

FIG. 9. Is a perspective illustration of an embodiment of the thermal device.

### DETAILED DESCRIPTION

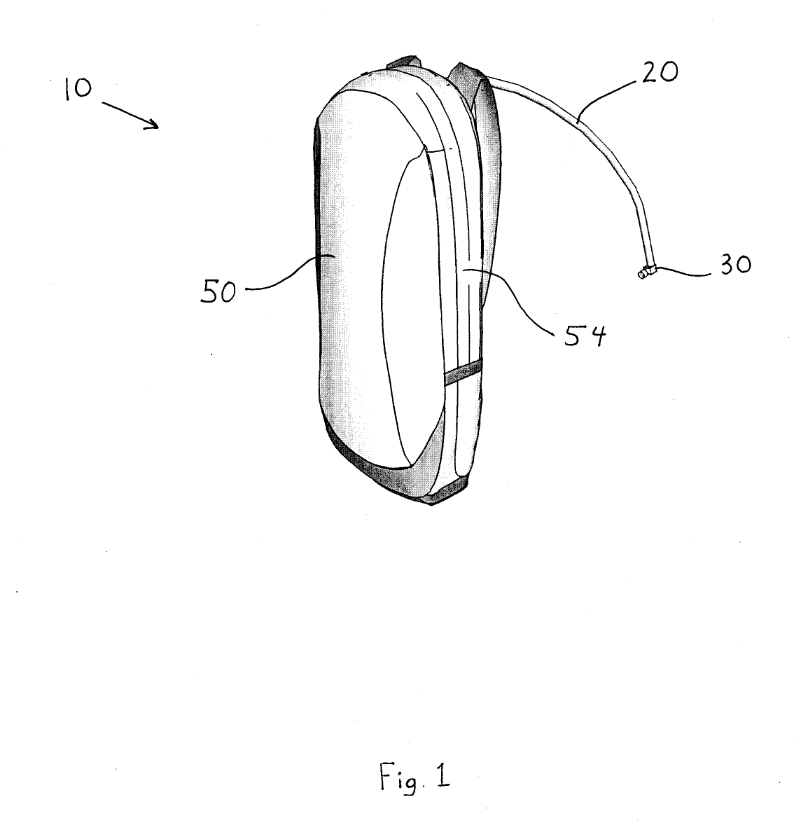

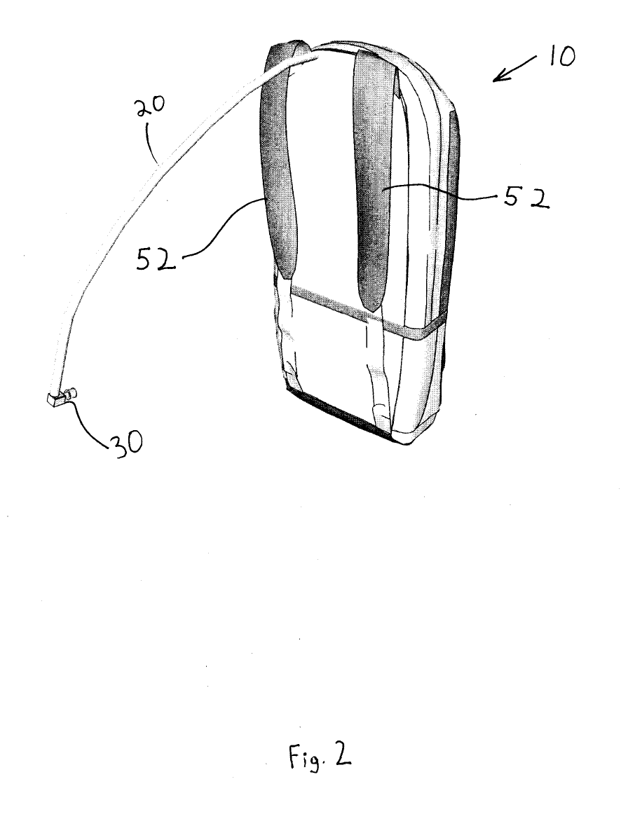

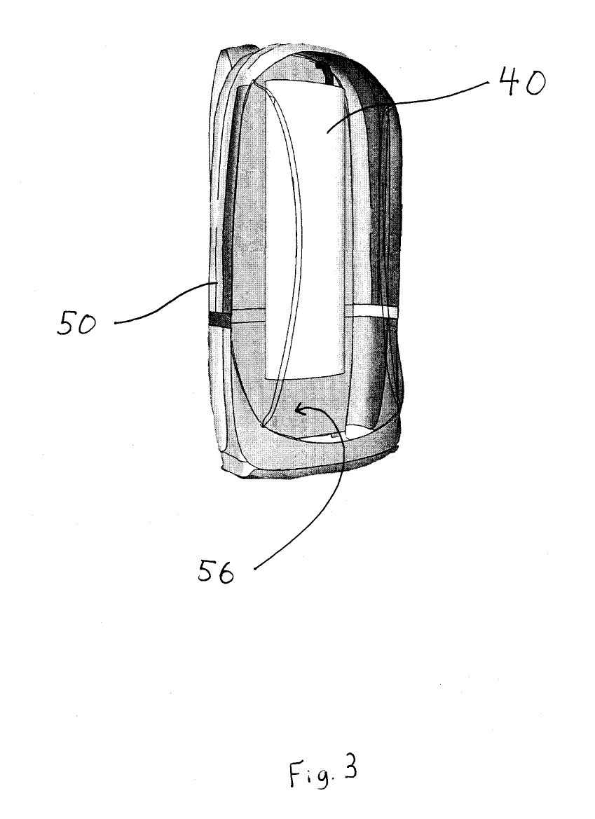

Referring now to the drawings, and in particular FIGS. 1-3, an embodiment of a hydration system 10 is illustrated. In one embodiment, personal hydration system 10 includes a fluid delivery conduit 20, a mouthpiece 64 and a fluid reservoir 40 (shown in FIG. 3). The hydration system 10 may be referred to herein as a hydration pack. As used herein, the term “personal hydration system” refers to a portable liquid carrying system. For example, a portable liquid carrying system capable of being carried by an individual, which may be used by runners, skiers, mountain bikers, road cyclists, hikers, walkers, surfers, beachgoers, picnickers, individuals attending sporting events, athletes, and the like. In some embodiments, the fluid reservoir 40 is disposed within a carrying device 50. In the exemplary embodiment, the carrying device 50 includes a pair of straps 52 coupled to an outer flexible cover 54. Although carrying device 50 is shown with two straps 52, it will be understood that any number of straps or handles, or none at all, may be used. In some embodiments, the carrying device 50 is a backpack, shoulder pack, hip pack, waist pack, messenger bag, other personal wearable pack, carrying pack or the like. In some embodiments, fluid reservoir 40 is a flexible bladder, a semi-rigid bladder, or a rigid bladder. In other embodiments, fluid reservoir 40 is a bottle. In yet other embodiments, fluid reservoir 40 is refillable. It is noted that FIG. 3 is illustrated with a portion of the cover 54 removed, so that reservoir 40 is viewable. Although reservoir 40 is shown as being stowed within an inner volume 56 of the cover 54, one of skill in the art will appreciate that the reservoir could be stowed on an outside of the cover 54, or the reservoir may be used without any cover 54. FIG. 2 shows a backside view of the hydration system 10. As used herein, the terms “back,” “front,” “top” and “bottom” are used to refer to the hydration system in a normal, upright position as the system would be position in regular use by a user.

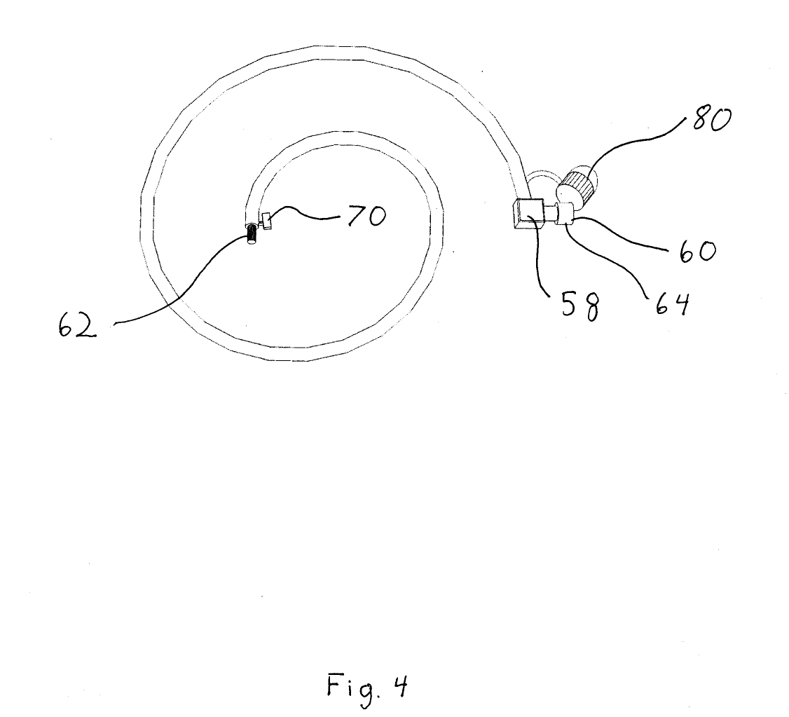

As best shown in the embodiment of FIG. 4, the fluid delivery conduit 20 includes a mouthpiece connecting portion 58 and a fluid outlet 60. The fluid outlet 60 may include a bite valve, orifice, mouthpiece, or any other device that allows a liquid to be dispensed or consumed therefrom. At an end opposite to the fluid outlet 60, the fluid delivery conduit 20 includes a reservoir connecting portion 62, configured to be coupled to the reservoir 40 such that it is in fluid communication therewith. In one embodiment, the reservoir connecting portion 62 is configured to be connected to the fluid reservoir 40, for example by a friction fit, a clamp, adhesive, or any suitable coupling that provides a substantially liquid tight fluid communication with the reservoir 40. In another embodiment, reservoir connecting portion 62 is connected to fluid reservoir 40 via a flow adjustment member 70, such as a valve, flow metering device, or the like.

In the embodiment shown in FIG. 4, the fluid outlet 60 includes a mouthpiece 64. Mouthpiece 64 may be sized and/or configured to fit within a user's mouth, and may be fabricated of a flexible material such as rubber, plastic, silicone or the like. In one embodiment, mouthpiece 64 includes a bite valve, one way valve, or other shut off device configured to stop a flow of liquid therethrough. In one embodiment, mouthpiece 64 is connected to fluid delivery conduit 20 by way of a mouthpiece connecting portion 58 using a friction fit or other substantially liquid tight coupling or seal. In other embodiments, mouthpiece 64 is sized to fit directly to fluid delivery conduit 20 in substantially leak-free engagement therewith. In one embodiment, fluid outlet 60 is supplied with a cap 80 configured to at least partially cover the fluid outlet 60 and/or mouthpiece 64. The cap 80 may provide a substantially liquid tight seal with the fluid outlet 60, and may additionally provide a barrier to dirt or other debris or contamination. In one embodiment, the cap 80 includes an antimicrobial agent to facilitate cleaning or antibacterial cleansing of the fluid outlet 60 and/or mouthpiece 64. In one embodiment, fluid delivery conduit 20 is a flexible tube, straw, hose or the like.

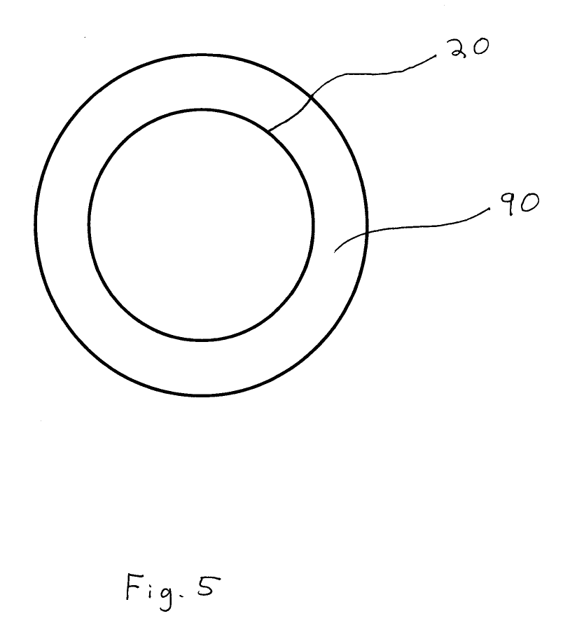

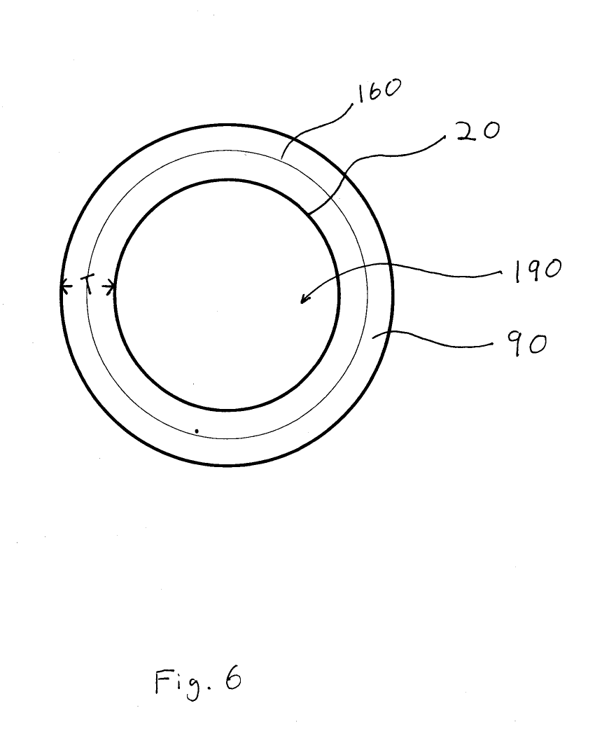

As shown in FIGS. 5 and 6, fluid delivery conduit 20 may have a cross-sectional shape of a circle. However, the fluid delivery conduit 20 may have any cross-sectional shape, such as oval, square, rectangular, any other polygonal or geometric shape allowing the fluid delivery conduit 20 to function as described herein. In some embodiments, fluid delivery conduit 20 is fabricated of a flexible or rigid material, or includes at least one rigid section and at least one flexible section, or combinations thereof.

In one embodiment, for example as shown in FIGS. 5 and 6, a sheath 90 is provided to at least partially cover fluid delivery conduit 20. As used herein, the term sheath includes a component capable of at least partially surrounding or otherwise covering fluid delivery conduit 20, such as a flexible sleeve, sock, wrap, or the like. In one embodiment, sheath 90 is fabricated of a thermally insulating material, such as a fabric, neoprene, rubber and the like.

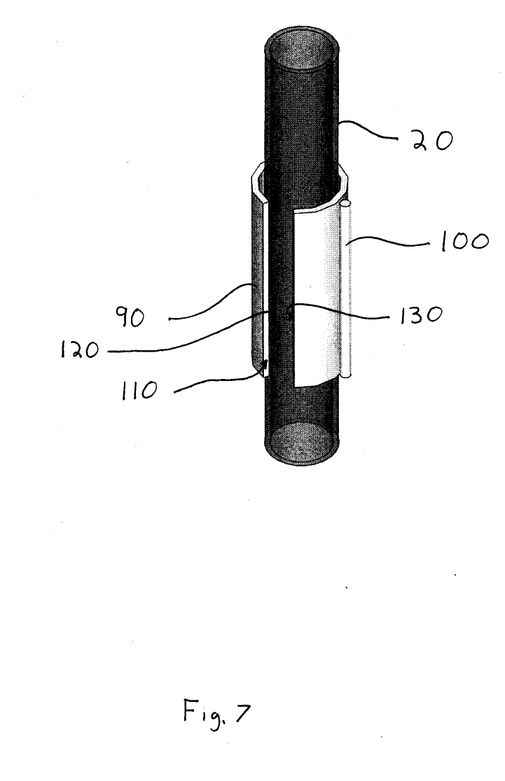

In the embodiment illustrated in FIG. 7, sheath 90 includes a positioning member 100, such as a semi-flexible wire, that runs longitudinally along sheath 90. The positioning member 100 may be configured to retain its shape once bent, thus allowing sheath 90, to stay in a user defined position. In another embodiment, sheath 90 comprises a slit 110, defined by edges 120, 130, that runs longitudinally along sheath 90. Slit 110 may allow a user to insert fluid delivery conduit 20 into sheath 90 in the open position, as shown in FIG. 7. Sheath 90 may then be closed/secured around fluid delivery conduit 20 by securing edge 120 to second edge 130 of the sheath, for example using Velcro, an adhesive, or any suitable mechanical fastener or the like. In one embodiment, first edge 120 and second edge 130 include a hook-and-loop type fastener securable by overlapping engagement with one another. In other embodiments, first edge 120 and second edge 130 include a fastener, such as a button, snap, zipper, adhesive, magnets and the like.

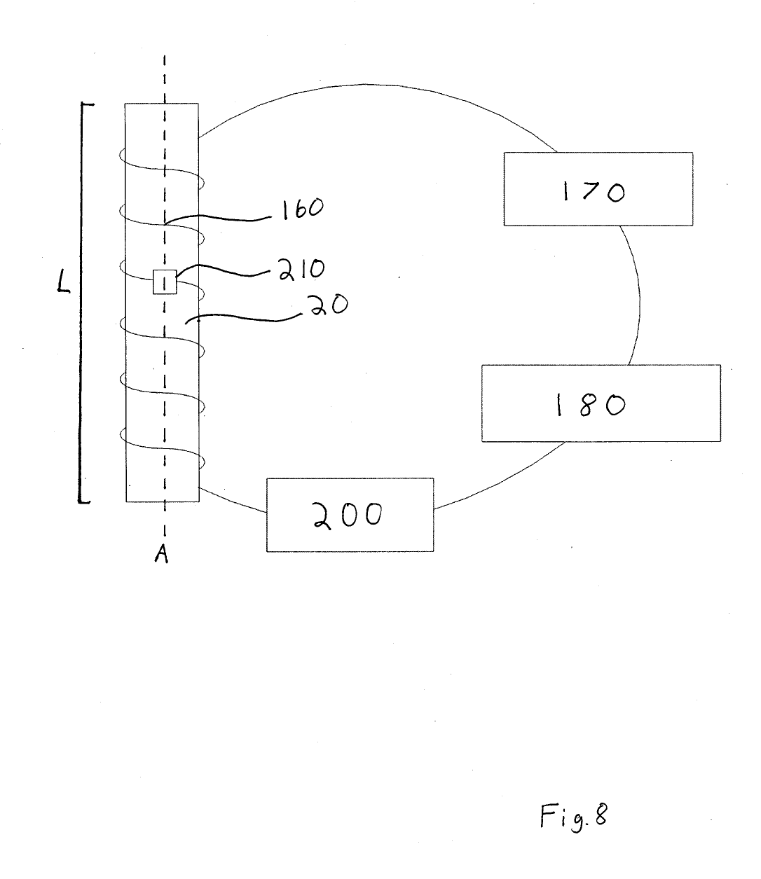

As shown for example in FIGS. 6 and 8, fluid delivery conduit 20 is in thermal communication with a thermal device 160. Thermal device 160 is configured to supply thermal energy, such as heat, to at least a portion of fluid delivery conduit 20. As shown, thermal device 160 is at least partially constructed of a heating element, such as resistance wire, for example nichrome, Kanthal or the like. Other resistance wires or heating elements may be used that provide sufficient heat upon being energized to allow the thermal device to function as described herein. As used herein, the term “energized” refers to application of energy, such as electrical energy, chemical energy, solar energy or other suitable energy to a component. In some embodiments, the thermal device 160 extends longitudinally (along longitudinal axis A) of at least a portion of the length L of the fluid delivery conduit 20 (best shown in FIG. 8). The thermal device 160 may extend linearly, or in a spiral (e.g., coiled) manner, such that it wraps at least partially around a portion of the fluid delivery conduit 20. In one embodiment, thermal device 160 extends only partially along fluid delivery conduit 20. In some embodiments, thermal device 160 may be releasable secured to fluid delivery conduit 20, for example by an adhesive, tape, Velcro or the like. In another embodiment, thermal device 160 is wrapped tightly around fluid delivery conduit 20, such that it is secured by way of the tension of the wrap. In yet other embodiments, thermal device 160 may be integrally formed with fluid delivery conduit 20, such that thermal device 160 is disposed at least partially within a thickness T of fluid delivery conduit 20, for example as shown in FIG. 6. In yet another embodiment, thermal device 160 is positioned within inner volume 190 of fluid delivery conduit 20, thus providing more direct contact with fluid within inner portion 190. In such embodiment, thermal device 160 may be coated with an electrically insulative material, such that electrical energy is not transmitted to a fluid within the fluid delivery conduit 20.

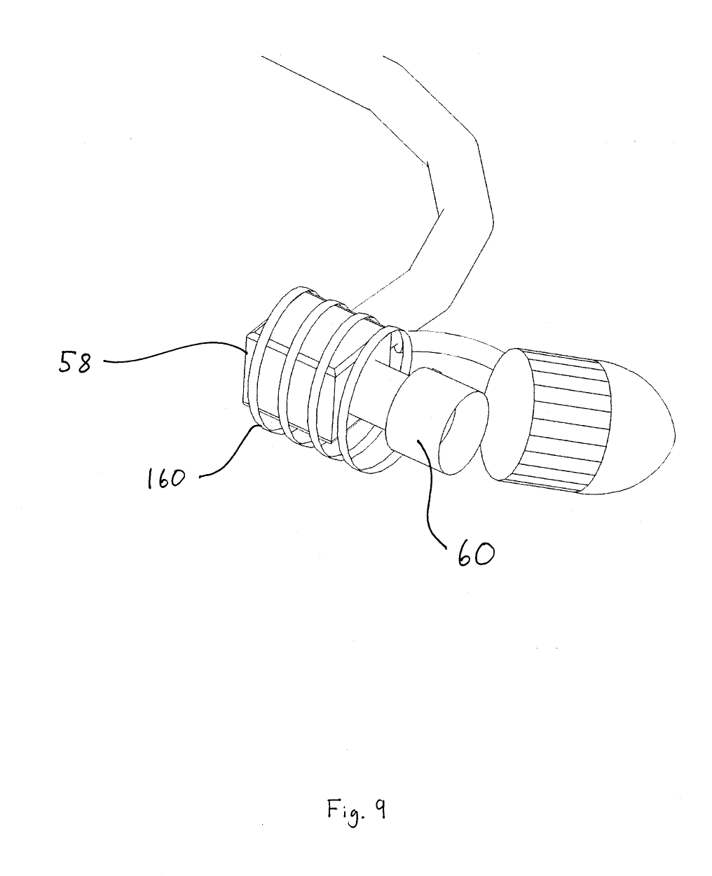

FIG. 8 illustrates an embodiment wherein thermal device 160 is wound around fluid delivery conduit 20. In yet another embodiment, for example as shown in FIG. 9, thermal device 160 is wound around at least a portion of fluid outlet 60 such that the thermal device 160 is in thermal contact therewith.

Referring back to FIG. 8, thermal device 160 is in electrical communication with an energy source 170 for energizing thermal device 160, for example by providing electrical energy thereto. When sufficient energy is supplied to thermal device 160, the thermal device 160 transfers heat to fluid delivery conduit 20, and/or to a fluid within fluid delivery conduit 20. In another embodiment, thermal device 160 is disposed within inner portion 190 of fluid delivery conduit 20, thus providing substantially direct contact with a fluid within inner portion 190, which may improve heat transfer to the fluid.

In one embodiment, thermal device 160 is in communication with energy source 170 via an energy regulating device 180. In one embodiment, energy regulating device is an on/off switch, rheostat, adjustable resistive device, digital controller or any other device capable of regulating or adjusting the energy supplied to the thermal device 160. In one such embodiment, energy regulating device 180 is a connector that connects thermal device 160 to energy source 170, thereby functioning as an “on/off switch” (e.g., the thermal device is on when connected, and off when disconnected to the energy source 170). In one embodiment, energy source 170 is a portable energy storage device such as a battery or other electrical or chemical energy storage cell. In another embodiment, energy source 170 may include a renewable energy source, such as one or more photovoltaic (i.e., solar) cells, solar heater or the like. Such renewable energy source may be in communication with the energy source 170 such that it recharges upon exposure to an external energy source.

In another embodiment, the amount of energy supplied to thermal device 160 is adjusted by controller 200, which may be a computer processor, digital device, or any other controlling device that allows the thermal device 160 to function as described herein. Controller 200 may be programmed/configured to adjust the amount of energy supplied to thermal device 160 in order to maintain a temperature of fluid delivery conduit 20, cap 80, mouthpiece 64 or fluid within any of fluid delivery conduit 20, cap 80, mouthpiece 64 above a predetermined temperature, such as above the freezing temperature of water, or the liquid to be contained within reservoir 40. In one embodiment, one or more temperature sensors 210 may be used in conjunction with the controller 200. For example, one or more temperature sensors 210 may be disposed along a portion of the thermal device 160, one or more of fluid delivery conduit 20, cap 80, mouthpiece 64, or anywhere on the hydration system 10 to supply temperature information to controller 200. For example, the temperature sensor may sense that the temperature of the liquid within the fluid delivery conduit 20 is at or near its freezing temperature, and relay the sensed temperature to the controller 200. The controller 200 thus adjusts the energy supplied to the thermal device 160, such that the liquid remains above its freezing temperature.

In one embodiment, cap 80 is coupled to sheath 90 and includes a thermal device 160, either together or separately from a thermal device coupled to other components of the hydration system 10. For example, in one embodiment, a single thermal device 160 runs along, on, or within, sheath 90 and cap 80. In another embodiment, cap 80 comprises a connector that allows a thermal device 160 disposed on or within cap 80 to be removably (electrically and/or physically) connected to one or more of sheath 90, fluid delivery conduit 20 and a thermal delivery device 160 running along, on, or within fluid delivery conduit 20. In yet another embodiment, the thermal device 160 is in thermal communication with the reservoir 40 to provide heat thereto.

In other embodiments, it is contemplated that fluid reservoir 40 may be a hand held reservoir, such as a water bottle. In such embodiments, mouthpiece 64 includes a cap for the water bottle. In this embodiment, thermal device 160 is disposed along, on or within the inner volume or outer surface of the water bottle and/or mouthpiece 64.

When introducing elements of the present disclosure or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. The term “embodiment” is used herein in an exemplary manner, and each disclosed embodiment may be combined with any and all elements of each other embodiment disclosed herein. Any of the components of the systems and methods disclosed herein may be integrally combined with one another, or separated into one or more individual components without departing from the scope of the disclosure.

As various changes could be made in the above apparatus and methods without departing from the scope of the disclosure, it is intended that all matter contained in the above description and shown in the accompanying figures shall be interpreted as illustrative and not in a limiting sense.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A thermal control device for a personal hydration system, comprising:
a sheath for covering a fluid delivery conduit of the personal hydration system;
a thermal device in thermal communication with the sheath and configured to heat at least a portion of the fluid delivery conduit when the thermal device is energized; and
an energy source in communication with the thermal device for energizing the thermal device.

2. The device according to claim 1, further comprising an energy regulating device for regulating an amount of energy transmitted from the energy source to the thermal device.

3. The device according to claim 2, wherein the energy regulating device is configured for regulating the amount of energy supplied to the thermal device to maintain a temperature of a fluid within a portion of the fluid delivery conduit above a predetermined temperature.

4. The device according to claim 1, further comprising a thermal insulator covering at least a portion of the fluid delivery conduit.

5. The device according to claim 1, wherein the thermal device comprises resistance wire.

6. The device according to claim 1, further comprising a mouthpiece in fluid communication with the fluid delivery conduit.

7. The device according to claim 6, wherein the thermal device is in thermal communication with the mouthpiece.

8. The device according to claim 1, wherein the thermal device is removably attachable to the fluid delivery conduit.

9. The device according to claim 8, wherein the thermal device is disposed at least partially within the sheath.

10. The device according to claim 1, wherein the energy source comprises a portable energy storage device.

11. The device according to claim 1, further comprising an energy regulating device configured to regulate an amount of energy supplied from the energy source to the thermal device.

12. A personal hydration system, comprising:
a fluid reservoir configured to hold a quantity of liquid,
a fluid delivery conduit in fluid communication with the reservoir,
a thermal device in thermal communication with the fluid delivery conduit, configured to transmit thermal energy to at least a portion of the fluid delivery conduit; and
an energy supply in communication with the thermal device and configured to energize the thermal device.

13. The personal hydration system according to claim 12, further comprising an energy regulating device configured to regulate an amount of energy supplied to the thermal device from the energy supply.

14. The personal hydration system according to claim 12, wherein the fluid reservoir is a flexible bladder and the fluid delivery conduit is a flexible tube.

15. The personal hydration system according to claim 12, wherein the thermal device at least partially covered by a thermally insulating sheath.

16. The personal hydration system according to claim 12, further comprising a mouthpiece in fluid communication with the fluid delivery conduit and in thermal communication with the thermal device.

17. A thermal system for a personal hydration system, comprising:
a thermal device configured to be in thermal communication with at least a portion of the personal hydration system, and
an energy source in communication with the thermal device and configured to selectively energize the thermal device.

18. The thermal system according to claim 17, wherein the thermal device is in thermal communication with a cap.

19. The thermal system according to claim 17, wherein the thermal device is in thermal communication with a reservoir of the personal hydration system.

20. The thermal system according to claim 17, further comprising a temperature sensor and a controller, the controller configured to regulate an amount of energy transmitted from the energy source to the thermal device based upon a temperature sensed by the temperature sensor.
